(19) United States
(12) Patent Application Publication
(10) Pub. No.: US 2015/0285202 A1
(43) Pub. Date: Oct. 8, 2015

(54) METHOD AND APPARATUS FOR CONTROLLING AN INTERNAL COMBUSTION ENGINE DURING AUTOSTOP AND AUTOSTART OPERATIONS

(71) Applicant: GM GLOBAL TECHNOLOGY OPERATIONS LLC, Detroit, MI (US)

(72) Inventors: Brian L. Spohn, Holly, MI (US); Michael William Roblin, North Royalton, OH (US); Paul S. Lombardo, Commerce Township, MI (US)

(73) Assignee: GM GLOBAL TECHNOLOGY OPERATIONS LLC, Detroit, MI (US)

(21) Appl. No.: 14/242,958

(22) Filed: Apr. 2, 2014

(51) Int. Cl. F02N 11/08

(52) U.S. Cl. CPC F02N 11/0814

(57) ABSTRACT

An internal combustion engine is configured to execute autostop and autostart routines. The engine is controlled during execution of the autostop routine to decrease quantity of combustibles in cylinder charges and increase dilution of the cylinder charges with the engine operating in a fuel cutoff mode and to achieve a stopped engine position that minimizes likelihood of auto-ignition during a subsequent autostart event.

### TECHNICAL FIELD

This disclosure is related to control systems for internal combustion engines.

### BACKGROUND

The statements in this section merely provide background information related to the present disclosure. Accordingly, such statements are not intended to constitute an admission of prior art.

Ground vehicles employ powertrain systems including internal combustion engines that generate propulsion torque to effect vehicle motion. Some powertrain configurations also employ non-combustion torque machines to generate propulsion torque that supplements and/or supplants power from the internal combustion engine during vehicle operation. Known powertrain systems execute engine autostop and autostart operations during ongoing powertrain operation.

An internal combustion engine has one or more cylinders housing reciprocating pistons that form variable displacement combustion chambers. The pistons are coupled to a crankshaft that transfers combustion power to a driveline via a transmission device. Known engines experience cylinder blow-by, wherein a portion of the combustion gases move between the cylinder walls and cylinder rings into a crankcase during cylinder compression. Crankcase gases can also move from the crankcase past the pistons into the combustion chamber, e.g., during an engine-off state and during engine starting prior to engine firing. Fuel injector tip leakage can also cause unburned fuel to enter a combustion chamber when an engine is in an engine-off state.

Powertrain systems include transmission devices and internal combustion engines, including configurations in which the engine executes autostop and autostart events during ongoing powertrain operation. Such powertrain systems may be configured to transmit torque originating from multiple torque generative devices, e.g., the engine and a non-combustion torque machine, through the transmission device to an output member that may be coupled to a driveline. Such powertrain systems include hybrid powertrain systems and extended-range electric vehicle systems.

During both engine autostop events and engine autostart events, compression torque pulses are generated in individual engine cylinders and transmitted to an engine crankshaft and a transmission input member, which may result in objectionable vibrations reaching a vehicle operator at resonant frequencies for the powertrain and various driveline components. The compression torque pulses can disturb engine output torque and can result in objectionable physical vibration and audible noise. Any unburned fuel and crankcase gases that are contained in combustion chambers can combust during engine autostarting and thus exacerbate compression torque pulses and related objectionable vibrations.

### SUMMARY

An internal combustion engine is configured to execute autostop and autostart routines. The engine is controlled during execution of the autostop routine to decrease quantity of combustibles in cylinder charges and increase dilution of the cylinder charges with the engine operating in a fuel cutoff mode and to achieve a stopped engine position that minimizes likelihood of auto-ignition during a subsequent autostart event.

### BRIEF DESCRIPTION OF THE DRAWINGS

One or more embodiments will now be described, by way of example, with reference to the accompanying drawings, in which:

FIG. 1 illustrates a spark-ignited, direct-injection internal combustion engine, in accordance with the present disclosure;

FIG. 2 illustrates an autostop execution routine that includes an auto-ignition mitigation autostop routine, in accordance with the disclosure;

FIG. 3 illustrates a plurality of engine control and operating parameters during execution of an autostop event that includes data associated with execution of an NVH-optimized autostop routine and data associated with execution of the auto-ignition mitigation autostop routine of FIG. 2, in accordance with the disclosure; and

FIG. 4 illustrates in-cylinder pressure axis in relation to time, and depicts torque output from an exemplary V8 engine operating during an autostart event with the engine starting from initial starting rotational positions of 15°, 30°, 45°, 60°, 75° and 90°, in accordance with the disclosure.

### DETAILED DESCRIPTION

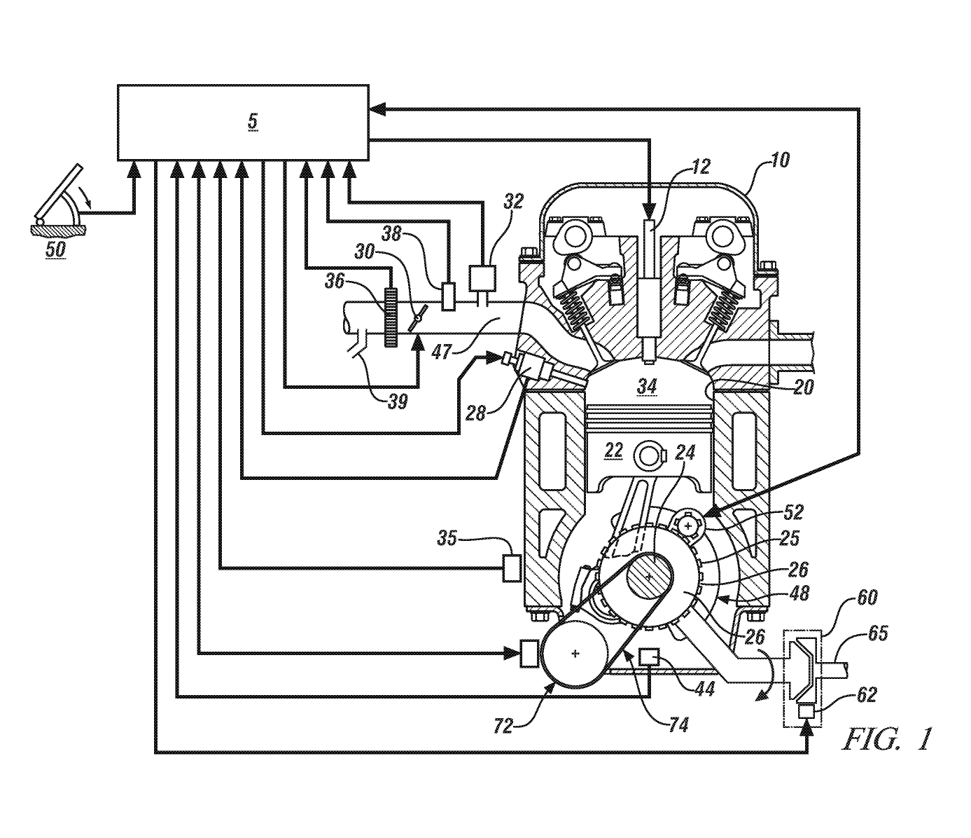

Referring now to the drawings, wherein the showings are for the purpose of illustrating certain exemplary embodiments only and not for the purpose of limiting the same, FIG. 1 is a schematic diagram depicting an internal combustion engine 10 and controller 5 in accordance with the present disclosure. The exemplary engine 10 is a multi-cylinder, spark-ignition, direct-injection internal combustion engine 10 having a plurality of reciprocating pistons 22 attached to a crankshaft 24. The pistons are movable in cylinders 20 and define variable volume combustion chambers 34. The engine 10 alternatively employs other fueling mechanizations, including, e.g., port-injection fueling or throttle-body fueling. The engine 10 is configured to execute autostop and autostart control routines during ongoing operation, with such configuration including a dedicated starter motor 52 in one embodiment. The starter motor 52 preferably includes a low-voltage (e.g., 12 Vdc) electric motor with a retractable pinion gear that meshingly engages a ring gear 25 of an engine flywheel 26 rotatably coupled to the crankshaft 24 during engine starting. In one embodiment, a non-combustion torque machine 72 rotatably couples to the crankshaft 24 of the engine 10 to rotate in concert therewith. In one embodiment the torque machine 72 rotatably couples to the crankshaft 24 employing a belt-alternator-starter (BAS) system 74. In one embodiment, the engine 10 is employed in a vehicle and is configured to execute autostop and autostart control routines during ongoing operation of the vehicle. In one embodiment, the non-combustion torque machine 72 is a high-voltage electrically-powered device. When the engine 10 is employed on-vehicle, the crankshaft 24 rotatably attaches to a vehicle transmission and driveline 65 to deliver propulsion torque thereto in response to an operator torque request. In one embodiment, the crankshaft 24 rotatably attaches to the transmission and driveline 65 through a torque converter 60 that preferably includes a controllable torque converter clutch 62. Alternatively, the engine 10 may be employed on a stationary device that commands intermittent engine operation, such as a remote-located electric power generator or air compressor. This disclosure is intended to include various configuration of the internal combustion engine 10 as described, but the scope of the concepts described herein is not limited thereby.

The engine 10 preferably employs a four-stroke operation wherein each engine combustion cycle has 720 degrees of angular rotation of the crankshaft 24 that include intake, compression, expansion, and exhaust strokes, describing reciprocating movement of each of the pistons 22 in the engine cylinder 20. A variable volume combustion chamber 34 is defined by the piston 22 reciprocating within the cylinder 20 between top-dead-center and bottom-dead-center locations and a cylinder head including one or more intake valve(s) and one or more exhaust valve(s). The piston 22 reciprocates in the cylinder 20 in concert with rotation of the crankshaft 24. Fuel injector 28 is configured to directly inject fuel into the combustion chamber 34 to mix with intake air to form a cylinder charge. Spark plug 12 is configured to ignite a cylinder charge in the combustion chamber 34. A throttle 30 is configured to control engine airflow, and preferably includes an electronically-controlled throttle device (ETC) that is controllable by the controller 5 in response to an operator torque request. The engine 10 is preferably configured with an exhaust gas recirculation (EGR) system 32 that recirculates exhaust gases into an intake manifold 47 during ongoing engine operation. The engine 10 is preferably configured with a positive crankcase ventilation (PCV) system 39 that filters and recirculates gases formed in an engine crankcase 48 into the intake manifold 47 during ongoing engine operation.

Sensing devices are installed on or near the engine 10 to monitor, e.g., temperature, pressure, and rotational position, and generate signals that are correlatable to engine and ambient parameters. The sensing devices include a crankshaft rotation sensor, including a crank sensor 44 for monitoring crankshaft speed (RPM) through sensing edges on the teeth of a multi-tooth target wheel attached to the engine flywheel 26. The crank sensor 44 may include, e.g., a Hall-effect sensor, an inductive sensor, a magnetoresistive sensor. A temperature sensor 35 is configured to monitor engine temperature, e.g., engine coolant temperature (ECT). The sensing devices and actuators are signally or operatively connected to control module 5. Other sensing devices preferably include a manifold pressure sensor 38 for monitoring manifold pressure (MAP) and ambient barometric pressure (BARO), and a mass air flow sensor 36 for monitoring intake mass air flow (MAF) and intake air temperature (IAT). The system may include an exhaust gas sensor for monitoring one or more exhaust gas parameters, e.g., temperature, air/fuel ratio, and constituents. One having ordinary skill in the art understands that there may be other sensing devices and methods for purposes of control and diagnostics.

The engine 10 operates over a broad range of temperatures, cylinder charges (air, fuel and EGR) and injection events. During operation of the engine 10, a combustion event occurs during each engine cycle when a fuel charge is injected into the combustion chamber 34 to form a cylinder charge with intake air including recirculated exhaust gas, PCV gas if present, and cylinder blow-by gas. The cylinder charge subsequently combusts, preferably by initiation of spark from a spark plug 12 during the compression stroke.

An operator interface device 50 captures an operator torque request originating from operator inputs to an accelerator pedal, a brake pedal, a transmission range selector (e.g., PRNDL) and other devices. The engine 10 is preferably equipped with other sensors for monitoring operation and for purposes of system control. Each of the sensing devices is signally connected to the control module 5 to provide signal information which is transformed by the control module 5 to states for the respective monitored parameter. It is understood that this configuration is illustrative, not restrictive, including the various sensing devices being replaceable with functionally equivalent devices and routines and still fall within the scope of the disclosure.

Control module, module, controller, control unit, processor and similar terms mean any suitable one or various combinations of one or more of Application Specific Integrated Circuit(s) (ASIC), electronic circuit(s), central processing unit(s) (preferably microprocessor(s)) and associated memory and storage (read only, programmable read only, random access, hard drive, etc.) executing one or more software or firmware programs, combinational logic circuit(s), input/output circuit(s) and devices, appropriate signal conditioning and buffer circuitry, and other suitable components to provide the described functionality. The control module has a set of control routines, including resident software program instructions and calibrations stored in memory and executed to provide the desired functions. The control routines are preferably executed during preset loop cycles. Routines are executed, such as by a central processing unit, and are operable to monitor inputs from sensing devices and other networked control modules, and execute control and diagnostic routines to control operation of actuators. Loop cycles may be executed at regular intervals, for example each 100 microseconds, 3.125, 6.25, 12.5, 25 and 100 milliseconds during ongoing engine and vehicle operation. Alternatively, routines may be executed in response to occurrence of an event.

The engine 10 is configured to execute autostart and autostop control routines and fuel cutoff (FCO) control routines during ongoing operation of the powertrain system, including a deceleration fuel cutoff (dFCO) control routine. A dFCO routine may be executed in response to an operator torque request to the operator interface device 50 that includes an operator completely lifting their foot off the accelerator pedal to effect vehicle coasting during ongoing vehicle operation. The engine 10 is considered to be in an OFF state when it is not rotating. The engine 10 is considered to be in an ON state when it is rotating, including one or more FCO states in which the engine is spinning and unfueled.

An engine autostop event includes discontinuing engine fueling and ramping down engine speed during ongoing powertrain operation until the engine speed is zero with the engine preferably resting at a desired stopped engine position (Θfinal). The desired stopped engine position is targeted to minimize initial engine starting combustion pressures to minimize transmitted vibrations and enhance an initial engine speed spinup associated with a known applied torque to the engine during a subsequent engine starting event, e.g., an autostart event. Engine speed control during an autostop event can be effected by controlling the non-combustion torque machine rotatably coupled to the engine on systems so configured. Engine speed control during an autostop event can be effected by controlling activation of a torque converter clutch or another controllable driveline torque management system on systems not employing non-combustion torque machines. In one embodiment, a preferred input speed ramping profile and desired stopped engine position are selected to ramp down the engine speed to a zero speed state while achieving the desired stopped engine position. The preferred input speed ramping profile takes into account engine and powertrain rotational inertias, engine pumping, and other factors that can be employed to determine a ramping profile that reflects a decrease in engine speed that does not require a power-consuming torque intervention that could increase battery discharge or otherwise negatively affect overall vehicle fuel economy. The desired stopped engine position is selected to minimize likelihood that combustion pressures will exceed a threshold pressure during engine starting.

The control module 5 executes routines stored therein to control the aforementioned actuators to control engine operation, including throttle position, fuel injection mass and timing, EGR valve position to control flow of recirculated exhaust gases, control of intake and/or exhaust valve timing, phasing and lift, on systems so equipped, and engine autostop and autostart control routines in response to engine and ambient operating conditions. This includes a method for controlling operation of the engine during execution of an autostop routine to decrease quantity of combustibles in a cylinder charge and to increase dilution of the cylinder charge, and controlling operation of the engine to achieve a desired stopped engine position that minimizes likelihood of auto-ignition during a subsequent autostart event. Auto-ignition refers to ignition of a cylinder charge prior to and without benefit of a spark discharge that occurs due to in-cylinder pressure and temperature conditions, including under conditions when formation of cylinder charges is incompletely controlled or managed, such as may occur during engine autostop and autostart events.

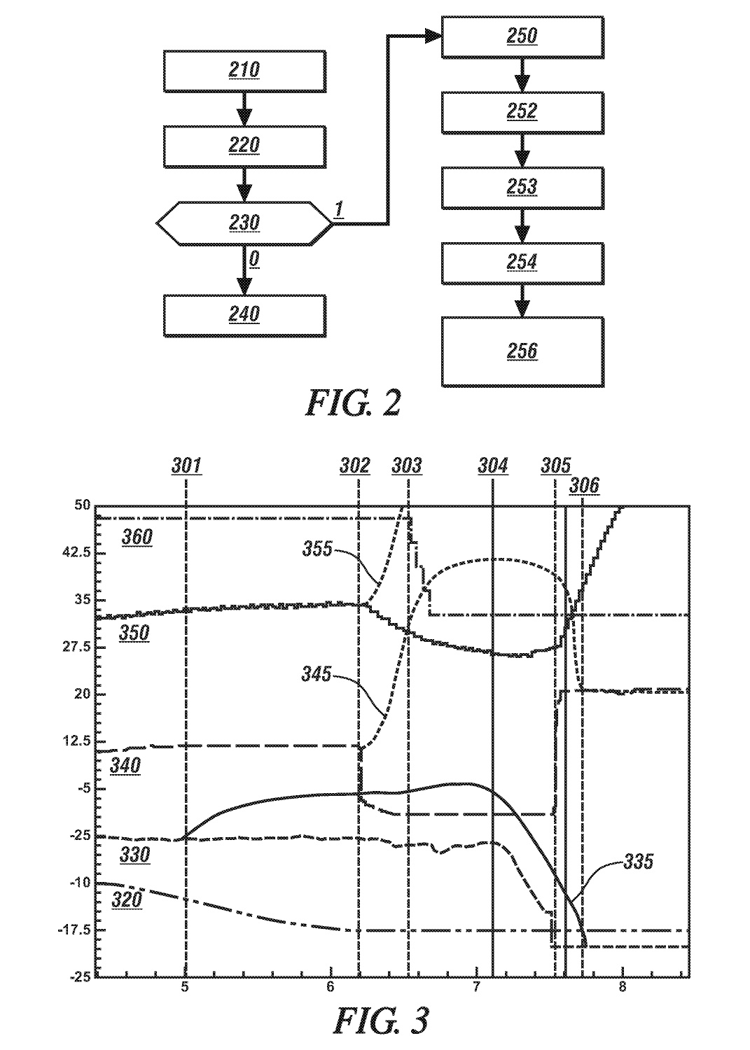

FIG. 2 is a flowchart of an autostop execution routine 200 that is executed in the controller 5 as one or a plurality of control routines to control operation of the engine 10 during on-going operation. Table 1 is provided as a key to FIG. 2 wherein the numerically labeled blocks and the corresponding functions are set forth as follows.

TABLE 1

| BLOCK | BLOCK CONTENTS |
|---|---|
| 210 | Command engine autostop |
| 220 | Review engine and ambient operating conditions |
| 230 | Execute auto-ignition mitigation autostop? |
| 240 | Execute NVH-minimization autostop |
| 250 | Execute auto-ignition mitigation autostop |
| 252 | Command engine fuel cutoff |
| 253 | Control engine speed |
| 254 | Command increased engine breathing to decrease quantity of |
| | combustibles in a cylinder charge and increase dilution of the |
| | cylinder charge in advance of achieving a stopped engine |
| | position |
| 256 | Control engine speed to achieve desired stopped engine |
| | position |

The autostop execution routine 200 executes in response to a request or command for engine autostop (210), which can occur during ongoing vehicle operation when the vehicle enters into conditions that are conducive to operating the vehicle with the engine in the OFF state. Such conditions can include when the vehicle is stopped at a traffic light or when the vehicle is parked/idling.

In response to the command for engine autostop, a plurality of engine and ambient conditions are monitored and reviewed to determine whether to execute an auto-ignition mitigation autostop routine (220). The engine and ambient conditions preferably include barometric pressure, engine fuel octane, coolant temperature, intake air temperature, exhaust gas temperature and in-cylinder temperature. The auto-ignition mitigation autostop routine is preferably executed when one or more of the present engine and/or ambient operating conditions indicate there is an increased likelihood of auto-ignition of cylinder charges during a subsequent engine starting event, e.g., an autostart event, and the remaining conditions do not preclude execution thereof (230). Thresholds associated with an unacceptable likelihood of auto-ignition of cylinder charges during autostart events can be determined using representative engines wherein engine and ambient operating conditions are induced over respective ranges with engine operation, specifically cylinder charge auto-ignition is monitored.

When the barometric pressure is less than a predetermined threshold, e.g., 85 kPa, there is an increased likelihood of auto-ignition during a subsequent autostart due to excessively high cylinder pressure, and thus the auto-ignition mitigation autostop routine may be executed to reduce auto-ignition of cylinder charges.

When there is an indication that the engine is presently operating with low octane fuel, there is increased likelihood of auto-ignition during a subsequent engine start. Low octane fuel increases likelihood of pre-ignition of a cylinder charge. Present engine operation employing a low octane spark map may indicate the engine is operating with low octane fuel. A spark map is a calibrated table executed in an engine controller that selects engine spark timing for a present engine speed/load/EGR operating condition. Under normal engine operating conditions, an MBT-spark map is calibrated to achieve MBT-torque for a present engine speed/load/EGR operating condition. Under engine operating conditions that include engine knock, such as sensed by an engine knock sensor, a low octane spark map is calibrated to select engine spark timing that achieves a best torque for a present engine speed/load/EGR operating condition that also minimizes engine knock or pre-ignition. Thus, there is increased likelihood of auto-ignition during a subsequent autostart when an engine control system is employing a low octane spark map to select engine spark timing due to presence of low octane fuel, and thus the auto-ignition mitigation autostop routine may be executed to reduce auto-ignition.

When there is an indication that the engine is presently operating at elevated engine coolant temperature and/or intake air temperature, there is increased likelihood of auto-ignition during a subsequent engine start due to elevated cylinder charge temperatures. Thus, the auto-ignition mitigation autostop routine may be executed when engine coolant temperature and/or intake air temperature exceed predetermined thresholds. This can include executing the auto-ignition mitigation autostop routine when the engine coolant temperature is greater than a first threshold, or when the intake air temperature is greater than a first threshold, or when both the engine coolant temperature and the intake air temperature are greater than corresponding second thresholds. This can include executing the auto-ignition mitigation autostop routine when the engine coolant temperature is greater than 120° C., or when the intake air temperature is greater than 65° C., or when both the engine coolant temperature is greater than 55° C. and the intake air temperature is greater than 115° C.

When there is an indication that the engine is presently operating at elevated exhaust gas temperature, there is increased likelihood of auto-ignition during a subsequent engine start due to elevated cylinder charge temperatures. Thus, the auto-ignition mitigation autostop routine may be executed when exhaust gas temperature exceeds a predetermined threshold. The exhaust gas temperature can be inferred from temperature of an exhaust gas sensor, e.g., an exhaust lambda sensor. Alternatively, the exhaust gas temperature can be estimated from a thermal state estimator routine based upon engine airflow, spark ignition or fuel injection timing, thermal mass of a combustion charge, air/fuel ratio, intake air temperature, manifold pressure and engine speed.

When there is an indication that the engine is presently operating at elevated engine piston temperature, there is increased likelihood of auto-ignition during a subsequent engine start due to elevated cylinder charge temperatures. Thus, the auto-ignition mitigation autostop routine may be executed when engine piston temperature exceeds a predetermined threshold. The engine piston temperature can be inferred from engine operating conditions.

When one or more of the present engine and/or ambient operating conditions fails indicate there is an increased likelihood of auto-ignition of cylinder charges during a subsequent autostart event or the remaining conditions preclude execution thereof (230)(0), the control routine executes an NVH-optimized autostop routine (240). The NVH-optimized autostop routine (240) includes controlling engine speed during an autostop event to achieve a desired stopped engine position that minimizes driveline vibration during the autostop event and during a subsequent autostart event.

When one or more of the present engine and/or ambient operating conditions indicates there is an increased likelihood of auto-ignition of cylinder charges during a subsequent autostart event and the remaining conditions do not preclude execution thereof (230)(1), the auto-ignition mitigation autostop routine executes (250).

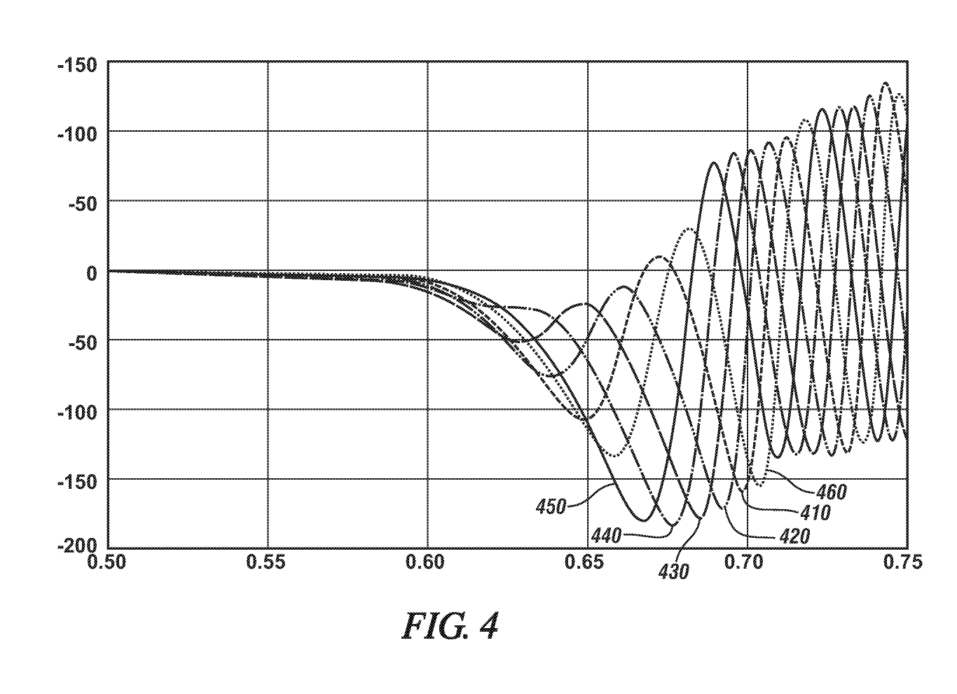

The auto-ignition mitigation autostop routine minimizes and otherwise mitigates a likelihood of auto-ignition during execution of a subsequent autostart routine by increasing dilution of cylinder charges and manifold air during the autostop control routine and reducing likelihood of ingesting combustible matter from the crankcase during the autostop event and the autostart event. This includes reducing presence of residual combustible material in the combustion chambers and intake manifold runners remaining from the most recent engine operation prior to the autostop event. This includes executing engine FCO early (252) and controlling the engine speed by controlling engine drag from the torque converter clutch or controlling the torque machine to control the engine speed, which can include controlling or permitting the engine speed to increase (253). Executing engine FCO early (252) includes executing the engine FCO immediately in response to a change in the operator torque request to a zero torque request. Controlling the engine speed includes selecting a preferred initial fueled engine speed and corresponding preferred initial motoring (unfueled) engine speed in preparation for a ramped stopping profile target speed, wherein the preferred initial fueled engine speed may be greater than the present engine speed. The preferred initial fueled engine speed may be achieved by increasing the torque machine speed on systems so equipped, or reducing torque converter slip across the torque converter to permit vehicle momentum to increase the engine speed. The control also includes executing one or more engine commands to increase engine breathing to decrease the quantity of combustibles in cylinder charges and increase dilution of the cylinder charges in advance of achieving a stopped engine position (254). The engine commands execute to open the throttle and adjust cam phasing to increase engine breathing and decrease engine rebreathing, i.e., decrease internal EGR during the autostop event. The process of increasing engine breathing acts to maximize air intake to dilute any residual combustibles, force such residual combustibles out of the intake manifold and cylinders, and reduce re-ingestion of such residual combustibles into combustion chambers by limiting intake/exhaust valve overlap during the engine cycles. Such operation reduces the likelihood of combustible products remaining in the intake manifold and combustion chambers from the most recent engine operation and reduces the amount of combustible material that is drawn from the engine crankcase past the piston rings into the combustion chambers during the autostop event. Opening of the throttle during an autostop event increases engine vibration and increases variation in stopped engine position, and is thus considered undesirable for engine stops when auto-ignition is unlikely during a subsequent autostart event. The auto-ignition mitigation autostop routine is intended to run when engine and ambient conditions indicate that auto-ignition is possible or likely during a subsequent engine autostart. The dilution of cylinder charges and manifold air during the autostop control routine is accomplished by an early execution of engine fuel cutoff and opening of the throttle to permit additional intake air during engine stopping. The engine speed can be controlled to achieve a desired stopped engine position that minimizes likelihood of auto-ignition and excessive combustion-induced vibration during a subsequent autostart event (256). Data associated with quantifying a desired stopped engine position that minimizes likelihood of auto-ignition and excessive combustion-induced vibration during a subsequent autostart event is illustrated in FIG. 4. Engine speed control is achieved by controlling engine drag from the torque converter clutch or controlling the torque machine. During execution of a subsequent autostart routine, a likelihood of auto-ignition can be minimized or otherwise mitigated by commanding the throttle valve to a closed condition prior to engine spin up to create a lower pressure in the manifold helping to eliminate the initial pressure which ultimately lowers the combustion pressure, thus making the likelihood of auto-ignition smaller.

FIG. 3 graphically shows a plurality of engine control and operating parameters during execution of an autostop event that includes data associated with execution of an NVH-optimized autostop routine and data associated with execution of the auto-ignition mitigation autostop routine of FIG. 2. Graphed parameters include vehicle speed 320, engine speed profile 330, 335, throttle position 340, 345, manifold pressure 350, 355 and engine fueling 360, which indicates a quantity of fueled cylinders.

Initially, while operating the NVH-optimized autostop routine, vehicle speed 320 is decreasing in response to an operator torque request that approaches a zero torque command, with a slight increase in the manifold pressure 350. At time 302, the vehicle speed 320 reaches a minimum speed, e.g., zero, prompting the control routine to close the throttle position 340 and discontinue engine fueling 360 beginning at time 303. The engine speed profile 330 is employed to control engine speed to a stopped position that is achieved at time 305, and the throttle position 340 is opened to a suitable position for executing a subsequent autostart event. Preferably the engine speed profile 330 is employed to control engine speed and position to achieve a preferred stopped engine position and corresponding initial engine position for executing the subsequent autostart event.

Initially, while operating the auto-ignition mitigation autostop routine, vehicle speed 320 is decreasing in response to an operator torque request that approaches a zero torque command, with a slight increase in the manifold pressure 355. At time 301, engine speed profile 335 commands an increase in engine speed. At time 302, the vehicle speed 320 reaches a minimum speed, e.g., zero, prompting the control routine to open the throttle position 345 with corresponding increase in manifold pressure 355. Engine fueling 360 is discontinued beginning at time 303. The engine speed profile 335 reaches a peak value at time 304 and begins to decrease to control engine speed to zero, which is achieved at time 306, and the throttle position 345 is controlled to a suitable initial engine position for executing a subsequent autostart event. Preferably the engine speed profile 335 is employed to control engine speed and position to achieve a preferred initial engine position to execute the subsequent autostart event and mitigate or eliminate auto-ignition.

An engine autostop event may be initiated after a vehicle has been operating in a dFCO state for a period of time, or may be initiated immediately in response to operator input to an accelerator pedal, thus affecting in-cylinder dilution and mitigating a need for execution of the auto-ignition mitigation autostop routine. By way of example, extended engine operation in the dFCO state prior to deciding to execute an engine autostop event may serve to dilute cylinder charges sufficient to preclude a need to execute the auto-ignition mitigation autostop routine.

Furthermore, a period of engine ON time since a previous engine autostop event may influence whether there is a need to execute the auto-ignition mitigation autostop routine. By way of example, an extended period of engine ON time may reduce a need to execute the auto-ignition mitigation autostop routine because extended warmed-up engine operation can reduce presence of unburned hydrocarbons on cylinder walls, thus reducing likelihood of auto-ignition during subsequent engine starting events. Furthermore, cumulative engine operating time may influence whether there is a need to execute the auto-ignition mitigation autostop routine due to a likelihood of presence of combustible material on cylinder walls.

FIG. 4 graphically shows in-cylinder pressure on the vertical axis in relation to time, and depicts torque output from an exemplary V8 engine operating during an autostart event with the engine starting from initial starting rotational positions of 15° 410, 30° 420, 45° 430, 60° 440, 75° 450 and 90° 460. By way of reference, for a V8 engine, thus if the engine rotation were to stop between two compression strokes, the natural position of the engine is around 45°. A review of the data shown indicates that there is a substantial difference between the in-cylinder pressure with the engine starting from an initial starting rotational position of 75° 450 and the in-cylinder pressure with the engine starting from an initial starting rotational position of 45° 430 or 15° 410. When the initial starting rotational position is 15° 410, the first peak pressure is slightly positive, whereas when the initial starting rotational position is 75° 450, the first peak pressure is greater than 60 kPa, which can be propagated through the vehicle and be readily discerned by a vehicle operator. Thus, controlling engine speed and position to achieve a desired stopped engine position can be employed to minimize combustion-induced vibration during subsequent autostart events. Such data can be developed for an engine system to determine a desired stopped engine position that minimizes combustion-induced vibration during a subsequent autostart event that is specific to the engine system. By way of example, a desired stopped engine position for an in-line four cylinder engine may differ from a desired stopped engine position for a six cylinder engine or a desired stopped engine position for another in-line four cylinder engine configuration.

The disclosure has described certain preferred embodiments and modifications thereto. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

1. A method for controlling an internal combustion engine configured to execute autostop and autostart routines, comprising:
controlling the engine during execution of the autostop routine to decrease quantity of combustibles in cylinder charges and increase dilution of the cylinder charges with the engine operating in a fuel cutoff mode and to achieve a stopped engine position that minimizes likelihood of auto-ignition during a subsequent autostart event.

2. The method of claim 1, wherein controlling the engine during execution of the autostop routine to achieve the stopped engine position that minimizes likelihood of auto-ignition during the subsequent autostart event comprises controlling operation of the engine during execution of the autostop routine to achieve a stopped engine position that minimizes combustion-induced vibration during the subsequent autostart event.

3. The method of claim 1, wherein controlling the engine during execution of the autostop routine to decrease quantity of combustibles in cylinder charges and to increase dilution of the cylinder charges with the engine operating in a fuel cutoff mode comprises increasing engine breathing.

4. A method for controlling an internal combustion engine configured to execute autostop and autostart routines, comprising:
controlling operation of the engine during execution of an autostop routine to decrease quantity of combustibles in cylinder charges and increase dilution of the cylinder charges in advance of achieving a stopped engine position; and
controlling operation of the engine during execution of the autostop routine to achieve a desired stopped engine position that reduces likelihood of an auto-ignition during a subsequent autostart event.

5. The method of claim 4, wherein controlling operation of the engine during execution of the autostop routine to achieve the desired stopped engine position comprises controlling engine drag from a torque converter to achieve a desired stopped engine position that reduces combustion-induced vibration during the subsequent autostart event.

6. The method of claim 4, wherein controlling operation of the engine during execution of the autostop routine to decrease quantity of combustibles in cylinder charges and to increase dilution of the cylinder charges comprises increasing engine speed, executing engine fuel cutoff and increasing engine breathing.

7. The method of claim 6, wherein increasing engine breathing comprises opening an engine throttle subsequent to increasing the engine speed.

8. The method of claim 7, wherein increasing engine breathing further comprises adjusting an intake cam phasing subsequent to increasing the engine speed.

9. The method of claim 7, wherein opening the engine throttle comprises opening the throttle to increase intake manifold pressure to a pressure that is greater than 80 kPa, abs.

10. The method of claim 4, further comprising:
monitoring engine and ambient conditions; and
wherein controlling operation of the engine during execution of the autostop routine to decrease quantity of combustibles in cylinder charges and to increase dilution of the cylinder charges occurs only when the monitored engine and ambient conditions indicate a likelihood of auto-ignition of cylinder charges during the subsequent autostart event.

11. A method for controlling a powertrain system including an internal combustion engine coupled to a torque machine, said engine configured to execute autostop and autostart routines, comprising:
controlling operation of the engine during execution of an autostop routine to decrease quantity of combustibles in cylinder charges and to increase dilution of the cylinder charges; and
controlling operation of the engine and the torque machine during the execution of the autostop routine to achieve a desired stopped engine position that minimizes likelihood of an auto-ignition during a subsequent autostart event.

12. The method of claim 11, wherein controlling operation of the engine and the torque machine during the execution of the autostop routine to achieve the desired stopped engine position that minimizes likelihood of auto-ignition during the subsequent autostart event comprises controlling torque transfer between the torque machine and the engine to achieve a desired stopped engine position that minimizes combustion-induced vibration during the subsequent autostart event.

13. The method of claim 12, wherein controlling torque transfer between the torque machine and the engine achieves a preferred engine speed profile to achieve the desired stopped engine position.

14. The method of claim 11, wherein controlling operation of the engine during execution of the autostop routine to decrease quantity of combustibles in the cylinder charges and to increase dilution of the cylinder charges comprises increasing engine speed, executing engine fuel cutoff and increasing engine breathing.

15. The method of claim 14, wherein increasing engine breathing comprises opening an engine throttle.

16. The method of claim 14, wherein increasing engine breathing comprises adjusting an intake cam phasing.

17. The method of claim 11, further comprising:
monitoring engine and ambient conditions; and
wherein controlling operation of the engine during execution of the autostop routine to decrease quantity of combustibles in cylinder charges and to increase dilution of the cylinder charges occursonly when the monitored engine and ambient conditions indicate a likelihood of auto-ignition of cylinder charges during the subsequent autostart event.
